(19) United States
(12) Patent Application Publication
(10) Pub. No.: US 2019/0161033 A1
(43) Pub. Date: May 30, 2019

(54) ROUTING STRUCTURE OF WIRE HARNESS

(71) Applicant: Yazaki Corporation, Tokyo (JP)

(72) Inventors: Shuuji SATAKE, Susono-shi (JP); Akinori MARUYAMA, Susono-shi (JP)

(73) Assignee: Yazaki Corporation, Tokyo (JP)

(21) Appl. No.: 16/190,525

(22) Filed: Nov. 14, 2018

(30) Foreign Application Priority Data
Nov. 28, 2017 (JP) 2017-228311

(51) Int. Cl. B60R 16/02; B60R 16/033

(52) U.S. Cl. CPC B60R 16/0215; B60R 16/033

(57) ABSTRACT

Provided is a routing structure of a wire harness that prevents an electric wire having a large cross-sectional area from being routed long in a vehicle, and facilitates routing. The routing structure of a wire harness connects between a power supply and loads mounted on the vehicle through one or more distributors, and a distributor to be connected first when viewed from the power supply is located in or behind a dashboard of the vehicle, or inside and in front of a center console box.

### TECHNICAL FIELD

The present invention relates to a routing structure of a wire harness.

### BACKGROUND ART

Various lamps and motors, switch devices for operating them, and a variety of loads such as a sensor are loaded with their being distributed in various places. And these various loads are connected with wire harnesses for supplying power supplied from a power supply such as a battery (Patent Document 1).

Also, in recent years, in hybrid vehicles and electric vehicles, there has been proposed what is provided with a driving power supply for a drive motor as a power supply, and a DC/DC converter that converts an output from the drive power supply into a power supply of a voltage corresponding to various loads other than the drive motor.

The power supply and the load are connected via one or a plurality of distributors. The distributor is an electronic device having a function of distributing its power source to various types of loads of a light system, electric equipment, electronic control equipment, electric machine, and is built in within a junction box (an electrical connection box). The distributor to be connected first as seen from the power supply was usually arranged in an engine room or a trunk room.

However, there are various lengths from the distributor to various loads, a cross-sectional area of the electric wire is large especially when a wire harness leading to a large number of loads to which a high voltage power supply is connected is long routed inside the vehicle from inside an engine room or the trunk room to the loads, so that weight and cost of the vehicle increases. Also, when the wire harness to which the high voltage power supply is connected is taken long, the wiring resistance increases, resulting in a decrease in efficiency.

### Patent Document

### Patent Document 1: Japanese Patent Application Laid-Open No. 2003-237499

### DISCLOSURE OF THE INVENTION

### Problems to be Solved by the Invention

The present invention has been made in view of the above background, and an object of the present invention is to provide a routing structure of a wire harness that suppresses a cable with large cross section from being routed long within a vehicle and facilitates routing.

### Means for Solving the Problems

The wire harness structure, which is an aspect of the present invention, has a structure in which a power supply and a load mounted in a vehicle are connected via one or more distributors. The distributor which is first connected as viewed from the power supply is arranged in or behind a dashboard or inside and in front of a center console box of the vehicle.

The power supply may output two power supplies of a high voltage and a low voltage.

In addition, the power supply may be constituted by a driving power supply, a DC/DC converter for converting an output from the driving power supply into two types of power supplies of the high-voltage power supply and the low-voltage power supply, and an auxiliary power supply arranged in parallel on a side of the low-voltage power supply.

Furthermore, the low-voltage power supply from at least one of the distributors may be connected to a CPU, via or not via a constant voltage device.

Then, the high-voltage power supply from the at least one of the distributors may be connected to the CPU via a low-voltage DC/DC converter converting the high-voltage power supply into the lower-voltage power supply.

### Advantageous of the Invention

According to the above-described aspect, it is possible to suppress the electric wire having a large cross-sectional area from being routed long, and facilitate routing.

### BRIEF DESCRIPTION OF THE DRAWINGS

FIG. 1 is a schematic view showing a routing structure of a wire harness according to a first embodiment of the present invention;

FIG. 2 is a schematic view schematically showing a structure up to a load 1 in the routing structure of the wiring harness shown in FIG. 1;

FIG. 3 is an explanatory diagram for explaining a connection state of the wire harness in the routing structure of the wiring harness shown in FIG. 1; and

FIG. 4 is a schematic cross-sectional view a relationship in a vehicle 8 as an example of a modified example in the case where a junction box (distributor) is arranged in front of a center console box.

### MODE FOR CARRYING OUT THE INVENTION

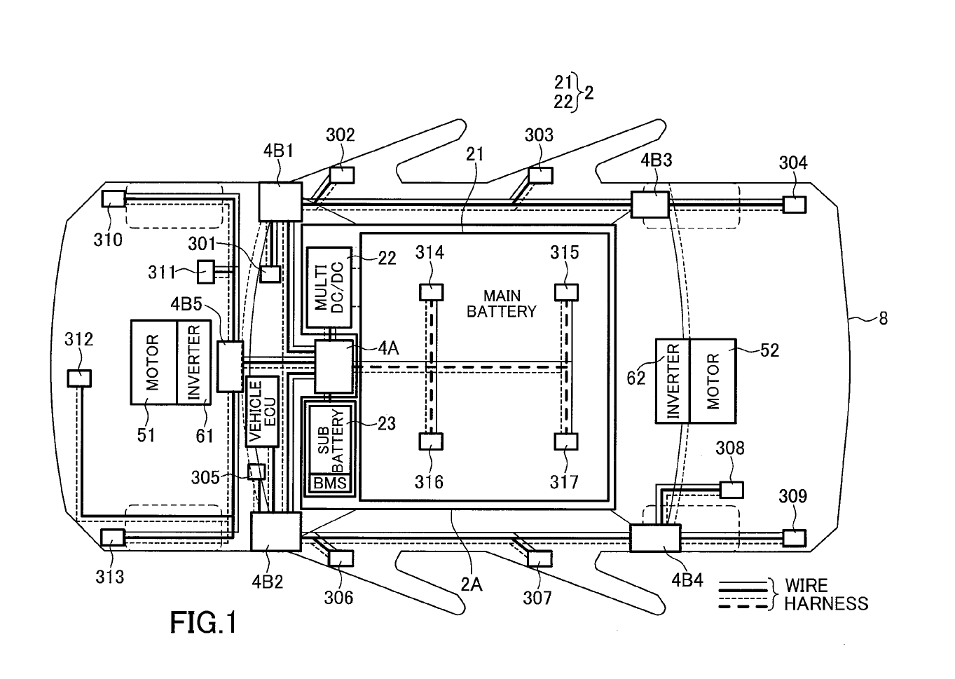

Hereinafter, embodiments of the present invention will be described with reference to FIGS. 1 to 3. A wire harness W/H shown in these figures (indicated by solid line (partially broken line) connecting each element in the figure) is what is routed in the vehicle 8, connects load drivers 301 to 317 (hereinafter sometimes simply referred to as “load driver 3”) that control operation of a power supply 2 and each load through a plurality of junction boxes 4A and 4B1 to 4B 5 having a built-in distributor, and supplies power from the power supply 2 to the load driver 3.

In the present embodiment, the statement “a junction box distributes” means a distribution by a distributor built in the junction box. The junction box generally incorporates various electronic parts or electronic devices such as fuse or a CPU, as necessary, together with the distributor.

The power supply 2 is constituted by a drive battery (drive power supply) 21 and a multi DC/DC converter 22. It is to be noted that the power supply 2 and a sub battery (auxiliary power supply) 23, which will be described later, constitute the battery unit 2A.

The drive battery 21 is a main battery of which a main purpose is to drive motors 51 and 52 that are power sources for driving a hybrid car, and is connected to the motors 51 and 52 through inverter circuits 61, 62 (not shown). The drive battery 21 is connected to the multi DC/DC converter, and its output is converted into two power supplies of a high voltage power supply (48 V in this example) and a low voltage power supply (12 V in this example), each of which is outputted to the junction box (distributor) 4A as power supply.

In the vehicle, since a load suitable for a high-voltage power supply, such as a load for obtaining power, and a load suitable for low voltage power supply such as a control means and lighting are mixed, it is desired to secure at least two types of power supply of high and low voltage. Therefore, according to the present embodiment, one drive battery can appropriately deal with various loads existing in the vehicle.

The junction box 4A is a distributor which is first connected when viewed from the power supply 2, and distributes the high voltage power supply and the low voltage power supply from the power supply to a plurality of load drivers 314 to 317 or other junction boxes 4B1, 4B2, 4B5. In addition, the Junction box 4B1, the junction box 4B2 and the junction box 4B5 which received power distribution from junction box 4A each distributes power to the load drivers 301-303 and junction box 4B3, load drivers 305-307 and the junction box 4B4, and the load drivers 310-313. The junction box 4B1, 4B2 which received distribution of power from the junction box 4A distribute power to the load driver 304 and the load drivers 308 and 309, respectively.

In this example, the junction box 4A is arranged in the instrument panel of the vehicle. In the vehicle, various loads, particularly loads requiring high-voltage power supply and the load which is precision equipment are concentrated in the periphery of the instrument panel, and arranging the junction box 4A in the vicinity where many such loads exist can suppress electric wires having a large cross sectional area from being routed long in the vehicle. Shortening the electric wire having the large cross sectional area can suppress increase in the weight and the cost of the vehicle, and also suppress the wiring resistance, and the efficiency from being lowered. Furthermore, since many electric wires including electric wires with large cross sectional area as well as other wires can be shortened, routing work becomes easy.

As a position where the junction box 4A is to be disposed, even in or behind the dashboard including the instrument panel, or inside and in front of the center console box, the distance from various loads is short, and thus the effect of the present invention is fully demonstrated.

Here, the statement of “in front of the center console box” means the front part of the shift lever in the center console box in the case of a floor-shifted vehicle, or refers to the front part including a position when a shift lever is assumed to exist in the case of no shift lever in the box in the column shift vehicle etc.

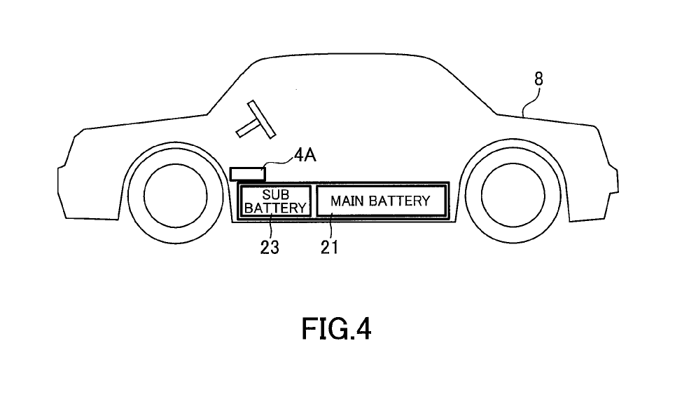

FIG. 4 shows, as an example of a modified example in the case where the junction box (distributor) 4A is disposed in front of the center console box, schematic sectional view showing a positional relationship in the vehicle 8. In the modification shown in FIG. 4, in the center console (not shown) of the vehicle interior of the vehicle 8, a sub battery 23 and a drive battery 21 are arranged in this order. The junction box 4A is arranged above the sub battery 2. This place is also extremely close to various loads, especially loads requiring high-voltage power supply, or a dashboard (especially the instrument panel) in which a load that is a precision instrument concentrates. According to this modified example in which the junction box 4A is disposed in this place, it is possible to prevent the electric wires having a large sectional area from being routed long in the vehicle 8.

In addition, once not the entire junction box but the function of the distributor is placed in these parts, the effect of the present invention can be achieved with no problem.

The loads controlled by the load drivers 301 to 317 are various electronic devices such as a light system, an illumination system, a display system, various electric equipment systems, electronic control equipment systems, electric equipment systems and the like. In this example, for example, the load drivers 302, 303, 306, 307 control operation of power window lifting devices, the load drivers 310 and 313 that of direction indicators, the load driver 312 that of a head lamp, and the load driver 314 to 317 that of a seat heater every seat. In FIG. 1, load drivers 314 to 317 seem to be included in the drive battery 21, the drive battery 21 is in reality arranged under the seat or under the floor, and the load drivers 314 to 317 that are the seat heater are disposed in the passenger compartment, so that they are physically separated upward and downward.

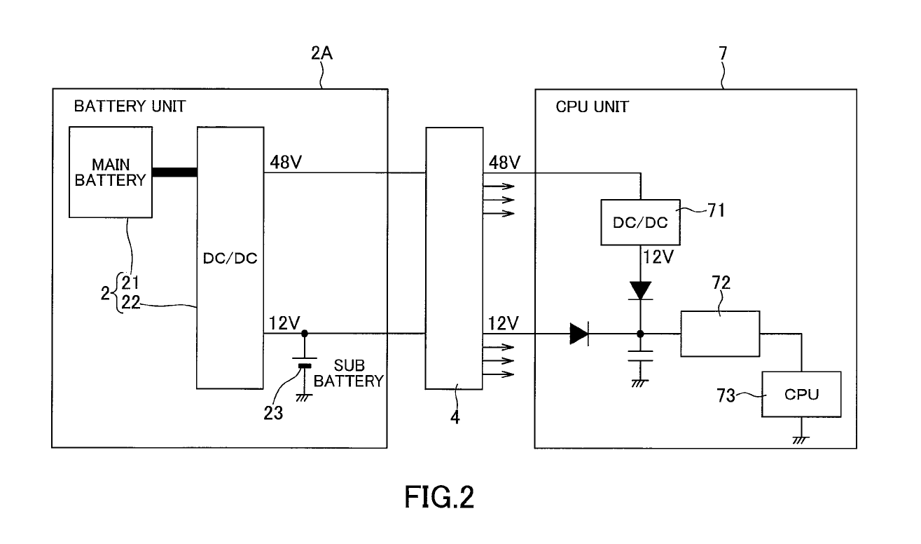

Each junction box 4A, and 4B 1 to 4B 5 (hereinafter referred to simply as “junction box 4” representing one among them. FIG. 2 shows the junction box 4 as the representative), has a CPU unit 7 built in responsive to the load of the distribution destination that becomes downstream (in FIG. 2, although the box 4 and the CPU unit 7 that each have a function different from each other are depicted as separate bodies, the CPU unit 7 is built in the casing of the junction box 4, actually in the present example).

The CPU unit 7 receives a low-voltage power supply 12 V from the power supply 2 via the junction box 4. On the other hand, in this example, the battery unit 2A is provided with a sub battery (auxiliary power supply) 23 arranged parallel to the output of the low voltage power supply 12 V. Provision of the battery 23, even if the low voltage power supply 12 V cannot be supplied from the power supply 2 due to disconnection of the wiring harness W/H or damage of the multi DC/DC converter barter 22 and the junction box 4, can supply the low voltage power supply 12 V from the sub battery 23. As a result, redundancy is ensured for the supply of the low voltage power supply 12V.

The load to be supplied with the low-voltage power supply 12 V includes many loads contributing to safety of the vehicle (for example, ECU or steering equipment, etc.) and emergency response (for example, communication device etc.), so that securing of the redundancy about the supply of low voltage power supply 12 V is desired for safe and secure traveling of the vehicle. According to the routing structure of the wire harness of the present embodiment, as even in the unlikely event, the supply of low voltage power supply 12 V is supplied from the sub battery 12 V, securing redundancy.

In the CPU unit 7, the supplied low voltage power supply 12 V is adjusted by a constant voltage device 72 to a desired voltage and is supplied to the CPU 73. Through the constant voltage device 72, the voltage value becomes desired one and stability can be guaranteed. The voltage value of the supplied low-voltage power supply 12 V, if no problem as it is and the stability is sufficient, may be supplied to the CPU 7 not through the constant voltage device 72.

On the other hand, the high voltage power supply 48 V from the power supply 2 is also supplied via the junction box 4. The CPU unit 7 is provided with a low-voltage DC/DC converter 71, and the supplied high voltage power supply 48 V is converted to a low voltage power supply 12 V by the low voltage DC/DC converter 71, and is connected to an input terminal of the constant voltage device 72. Therefore, separately from the route of the output low voltage power supply 12 V outputted from the junction box 4, low-voltage power supply 12V can also be supplied from the route of the high-voltage power supply 48V outputted from the junction box 4. Even when trouble occurs in the route of the low voltage power supply 12 V outputted from the junction box 4, since the low voltage power supply 12 V is received from the route of the high voltage power 48 V outputted from the junction box 4, higher redundancy is secured.

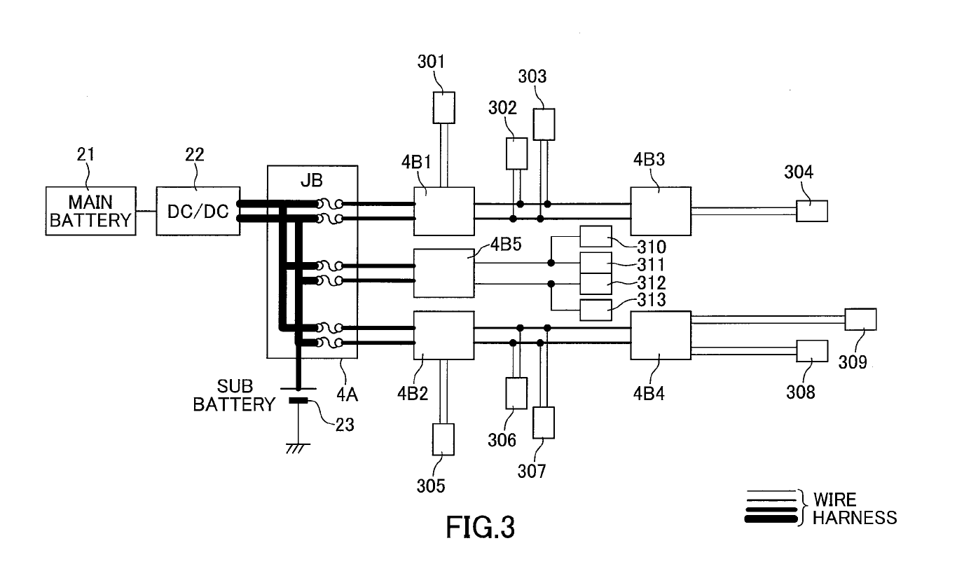

FIG. 3 is an explanatory diagram showing the connection state of the wire harness in the wiring harness routing structure of the present embodiment. In FIG. 3, The wire harness W/H downstream of the multi DC/DC converter 22 is schematically shown so that its line width shows the difference in the cross-sectional area of the actual wire.

The power converted by the multi DC/DC converter 22 (both the high voltage power supply and the low voltage power supply, which is similar in this section.) is supplied to the junction box 4A. In order to deal with all the loads that are loaded on the vehicle, the wire harness W/H up to the junction box 4A has a large current flow therethrough, and as shown in FIG. 3, an electric wire having a large cross sectional area is used.

Next, the power is distributed plurally at the junction box 4A to a load or a junction 4B1, 4B2, 4B5 (not shown), respectively. The current value, once distributed to the junction box 4B1, 4B2, 4B5, decreases by the divided amount, but still a relatively large current flows, and the wire harness W/H up to each junction box 4B1, 4B2, 4B5, as shown in FIG. 3, uses electric wire that has still relatively large cross sectional area. In the present embodiment, as described above, optimizing the position of the junction box 4A can keep routing of wires with a relatively large cross sectional area of this part short.

Furthermore, the power is distributed plurally at the junction boxes 4B1, 4B2, and 4B5, to each of the load drivers 301 to 303, 305 to 307, and 310 to 313 or the junction box 4B3 and 4B4 respectively. Next, the power is distributed plurally at the junction boxes 4B3, 4B4, respectively, and is supplied to the load drivers 304, 308, 309, respectively.

Since the number of loads ahead of the wiring harness W/H between the junction boxes 4B1, 4B2, and the junction boxes 4B3, 4B4 becomes smaller, the cross sectional area thereof to be used becomes considerably small, as shown in FIG. 3. And since the wire harness W/H between these junction boxes 4B1 to 4B5 and the load drivers 301 to 313 at each end is sufficient to supply the current necessary for each load, sectional area thereof becomes very small.

In this way, the sectional area of the electric wire in the wire harness W/H, as proceeding from the power supply 2 (the multi DC/DC converter 22) to the downstream side, gradually decreases. That is, according to the wiring harness routing structure of the present embodiment, since the junction box 4A is in an appropriate position that is first connected viewed from the power supply, the wire harness W/H made of a large cross sectional area results in shortness on the upstream, and branching off of the harness W/H as going away from the power supply, can gradually decrease the cross sectional area of the wire of the wire harness W/H by the downstream side. As a result, it is possible to suppress the increase in vehicle weight and cost, and also suppress the wiring resistance, and efficiency and voltage reduction can thus be suppressed.

As described above, the routing structure of the wire harness of the present invention will be described with reference to preferred embodiments. However, the routing structure of the wire harness of the present invention is not limited to the configuration of the above embodiment. For example, the above embodiment was explained taking five junction boxes (distributors), seventeen loads, but this number are not particularly limited, and no number is specified. Specially, the number of the load in the present embodiment rather decreases. In fact, apart from that, numerous loads of light system, illumination system and display system exist, and even in the electric equipment system, numerous loads of a door mirror, an electric seat, or an automatic lock mechanism exist, all of which can be a load referred to in the present invention.

In addition, persons skilled in the art can appropriately modify the routing structure of the wire harness of the present invention according to conventionally known knowledge. Even such a modification, as long as it has the wiring harness routing structure of the present invention is of course included in the scope of the present invention.

### DESCRIPTION OF SYMBOLS

W/H wire harness
2 power supply
2A battery unit
21 drive battery (drive power supply)
22 multi DC/DC converter
23 sub battery (auxiliary power supply)
3, 301 to 317 load driver
4 junction box (distributor)
4A, 4B1 to 4B5 junction box (distributor)
51, 52 motor (power source)
61, 62 inverter circuit
7 CPU unit
71 low voltage DC/DC converter
72 constant voltage device
73 CPU
8 vehicle

1. A routing structure of a wire harness for connecting a power supply and a load that are mounted on a vehicle, comprising:
one or more distributors via which the power supply and the load are connected, wherein
the distributor which is first connected as viewed from the power supply is arranged inside or behind a dashboard, or inside and in front of a center console box of the vehicle.

2. The routing structure of the wire harness according to claim 1, wherein the power supply outputs a high-voltage power supply and a low-voltage power supply.

3. The routing structure of the wire harness according to claim 2, wherein the power supply is constituted by a driving power supply, a DC/DC converter for converting an output from the driving power supply into two types of power supplies of the high-voltage power supply and the low-voltage power supply, and an auxiliary power supply arranged in parallel on a side of the low-voltage power supply.

4. The routing structure of the wire harness according to claim 1, wherein the low-voltage power supply from at least one of the distributors is connected to a CPU via or not via a constant voltage device.

5. The routing structure of the wire harness according to claim 2, wherein the low-voltage power supply from at least one of the distributors is connected to a CPU via or not via a constant voltage device.

6. The routing structure of the wire harness according to claim 3, wherein the low-voltage power supply from at least one of the distributors is connected to a CPU via or not via a constant voltage device.

7. The routing structure of the wire harness according to claim 4, wherein the high-voltage power supply from the at least one of the distributors is connected to the CPU via a low-voltage DC/DC converter converting the high-voltage power supply into the lower-voltage power supply.

8. The routing structure of the wire harness according to claim 5, wherein the high-voltage power supply from the at least one of the distributors is connected to the CPU via a low-voltage DC/DC converter converting the high-voltage power supply into the lower-voltage power supply.

9. The routing structure of the wire harness according to claim 6, wherein the high-voltage power supply from the at least one of the distributors is connected to the CPU via a low-voltage DC/DC converter converting the high-voltage power supply into the lower-voltage power supply.
